(19) United States
(12) Patent Application Publication
(10) Pub. No.: US 2007/0159460 A1
(43) Pub. Date: Jul. 12, 2007

(54) Device for entering values with a display screen

(75) Inventors: Martin Vogel, Sargans (CH); Rene Wussler, Regensdorf (CH)

Correspondence Address: BRINKS HOFER GILSON & LIONE, P.O. BOX 10395, CHICAGO, IL, 60610, US

(73) Assignee: Studer Professional Audio AG

(21) Appl. No.: 11/710,163

(22) Filed: Feb. 23, 2007

Related U.S. Application Data
(63) Continuation of application No. 09/807,445, filed on May 23, 2001, now Pat. No. 7,187,357.

(30) Foreign Application Priority Data
Oct. 26, 1998 (CH) 2153/98

(51) Int. Cl. G09G 5/00

(52) U.S. Cl. 345/156

(57) ABSTRACT

The invention relates to a device for entering values by using a display screen provided for displaying the values and by using at least one element for manually entering values. The device includes a support for the element which is connected to the display screen upstream in a viewing direction. The support includes at least one transparent area which is assigned to the element.

### PRIORITY CLAIM

This application is a continuation of the U.S. application Ser. No. 09/807,445, filed on May 23, 2001, which is the U.S. nationalization of International Application No. PCT/CH99/00498 filed on Oct. 21, 1999. The International Application No. PCT/CH99/00498 claims the benefit of Switzerland Patent Application No. 2153/98, filed Oct. 26, 1998. The disclosures of all of the above applications are incorporated herein by reference.

### BACKGROUND OF THE INVENTION

1. Technical Field

The invention relates to a device for entering values with a screen for displaying values and with at least one element for manual entry of the values provided in front the screen.

2. Related Art

Devices for the input of values are, e.g., rotating knobs and sliding levers that are connected to a dial from which the adjusted value can be read. Here, the feedback about the adjusted value is quickly recognizable and easy to survey. Such systems are well introduced and require little space. However, they cannot be configured, i.e., they cannot easily and quickly be reassigned to another task. Nor can they be operated by remote control. This disadvantage can be avoided by connecting a motor which moves the rotating knob or sliding lever. Such devices are known, but they are expensive and large.

In a further developmental stage, devices for entering can be separated from the display. Accordingly, rotating knobs or sliding levers and a display screen, are locally separated. The display screen can be embodied as a monitor. Such a device can be configured and controlled remotely. However, the operation is less advantageous since, if several such devices are provided in a tight area, the coordination between the entering element and the display element must be known or practiced. Frequently, the elements for the entering of values are locally separated so far from the display of the values that a correlation between the element and the display is not always ensured. Frequently, so many entry elements are provided that confusion is inevitable. For such types of devices, audio mixers are typical for sound signals, control panels for power plants or chemical arrangements, as well as operating surfaces for devices for medicinal technology, etc.

Another known embodiment for such devices with a screen is known from the technology of electronic computers, so called PC's. A cursor such as an arrow can be directed onto a field on the screen by means of a mouse. With the mouse, for example, a value can be selected from a given selection of values. Alternatively, originating from a given value, the next given value can be selected by an impulse from the mouse. Such an embodiment can be configured and controlled remotely, but it is comparatively slow in its operation. The lack of a directly acting entering knob leads to an awkward operation. The simultaneous operation of several entering devices is impossible.

Furthermore, devices with screens are known in which the display and value entering occur directly via the screen, i.e., operate without a mouse. On such screens, the program separates fields which, e.g., are to be touched by the finger in order to select one value among several values. Such systems are known by the term “touch screen.” They are easy to arrange and configure, and are quicker to operate than a mouse. However, each entry field on the screen requires a lot of space. The operation is perceived as uncomfortable when an operating finger of an operator has to perform a continuous, pushing motion, directed away from the body of the operator.

U.S. Pat. No. 5,572,239 describes a device including control elements, e.g., rotating or sliding knobs. The control elements are provided in front of a flat screen, which are connected to a transformer via a connecting element, such as a shaft, for example. The transformer transforms a motion or position of the control element into an electric signal. The transformer is mounted onto a carrier so that ultimately the control elements are positioned on this carrier as well. The carrier is positioned behind the flat screen, viewed in the viewing direction, and the connection to the control elements occurs via openings in the flat screen.

The control elements are positioned in front of the screen. Transformers are positioned behind the screen and convert the settings of the control elements. This is always contingent upon the connection made via the screen. No monitor containing a cathode ray tube can be used. Another disadvantage is that, by the utilization of control elements and separate transformers, an overall large amount of space is necessary, and the construction of such devices is expensive, in particular the application in an audio mixer.

### SUMMARY

It is the object of the invention to create a device which allows a secure, i.e., reliable and confusion free, but also quick feedback about values, which can be entered in an ergonomically advantageous manner by means of a manual entry element. The device also may lead to a constructive design that requires little space and can easily be constructed.

For this purpose, a carrier for the elements for manual entering is positioned in front of the screen, as seen in the viewing direction, in the device according to the invention. Insofar as the carrier covers the entire screen, it is provided with at least one transparent region correlated to the element for the display of values on the screen. The elements are connected by way of connections in front of the screen to the computer which enters the setting of the elements for the manual entering of data and, in at least one region of the screen, a feedback of the adjusted values is displayed. Preferably, an element for mounting electronic components is correlated to the screen and the carrier. The element for mounting electronic components is preferably positioned between the carrier and the screen and, depending on the configuration, is provided with transparent regions at least whenever it covers the entire screen. It can be positioned directly at the carrier as well (e.g., applied as a foil) or be integrated therein. For example, rotating knobs, sliding levers, so called joy sticks, etc., i.e., sensors that are adjustable linearly or in two dimensions or directions can be used as entry elements. Such entry elements produce either a value according to their present setting or produce a signal which corresponds to a performed movement and produce increments of processing values, for instance.

One of the advantages achieved by the invention is the ability to provide a clear and secure feedback to the operator on recently adjusted values. As noted above, both spatial distance and visual distance have been present between the position in which the display occurs on a screen and the position in which a value entering occurs. In this invention, such distance is reduced and both elements are moved into the same view for display and operation. Thus, depending on the configuration, several displays and several entry elements can be set into the same view. Accordingly, for example, values can be changed simultaneously with both hands and immediately the valid values can be controlled for both entries simultaneously. Additionally, the device according to the invention allows the entering of values in quick sequences and is particularly “handy” or advantageous for operating with hands. When used in audio mixers for sound technology, it adapts to the habits of the sound masters to a large extent and thus supports their work in a positive manner. Because the control elements are directly connected to the computer via cables and the wires are mounted directly on the screen, a particularly simple construction results in a demand of a smaller space.

### BRIEF DESCRIPTION OF THE DRAWINGS

In the following, the invention is explained using an exemplary embodiment and drawings.

FIG. 1 shows a device according to prior art.

FIG. 2 is a cross sectional view of a part of the device.

FIGS. 3 and 4 are a cross sectional view of a part of the device.

FIG. 5 illustrates one exemplary view of the device.

FIG. 6 illustrates a detailed view of the device.

FIG. 7 is a schematic block diagram of the construction of the device with a computer.

FIG. 8 is a view of a device illustrating one exemplary configuration applied to multiple fields of a screen.

FIG. 9 is a view of a device illustrating different exemplary configuration applied to the multiple fields of the screen of FIG. 8.

### DETAILED DESCRIPTION OF THE PREFERRED EMBODIMENTS

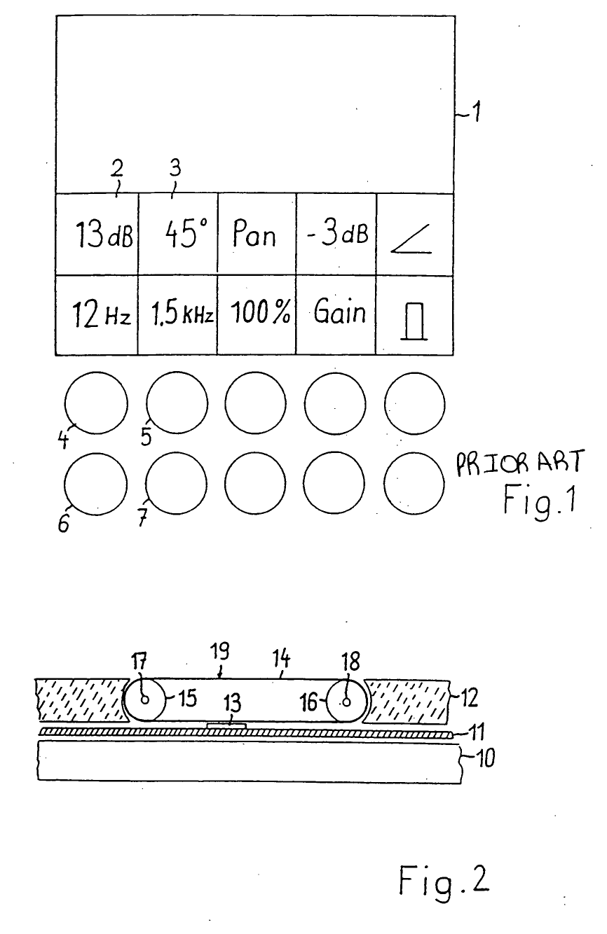

FIG. 1 shows a known embodiment of a device comprising a screen 1 and several fields 2, 3 etc. in which a value is displayed graphically, e.g., in the form of numbers. These two fields 2, 3 are correlated to rotating knobs 4, 5, e.g., by way of which values can be entered into the device. The displayed values in the fields 2, 3 can be modified by rotating the rotating knobs 4, 5. For this purpose, it must be known that the fields 2, 3 correspond to the rotating knobs 4, 5 and not to the rotating knobs 6, 7. In actual use, as a larger number of the rotating knobs are present, it is more difficult to identify and recognize the distance between the fields 2, 3 and the rotating knobs 4, 5, 6, 7. This results in insecurity during operation.

FIG. 2 shows a cross section through a part of the device according to the invention. FIG. 2 illustrates a part of the screen 10, a part of the element 11 for mounting electronic components, and a part of a carrier 12 for elements for entering values. Here, the element 11 is typically embodied as a printed circuit board on which strip conductors are mounted. In FIG. 2, an optically operating sensor 13 is mounted on the element 11. In this example, the sensor 13 cooperates with a belt 14 which rests on rolls 15, 16 which are positioned in the carrier 12 via the axes 17 and 18. The belt 14 comprises at least one marking initiating an electrical impulse when it is positioned opposite to the sensor 13. In order to enter values, the belt 14 can be moved on its upper side 19, using a finger, for instance. Here, a linear adjustable activator is used. The carrier 12 is constructed of a transparent material such as, for example, glass, plexiglass, mineral glass, etc. The carrier 12 is cut out in certain regions next to the belt and it is clear or not present. The carrier 12 can, e.g., be mounted on a cover sheet for the screen or on a common housing part. An incremental activator may be used for the sensor 13, for instance.

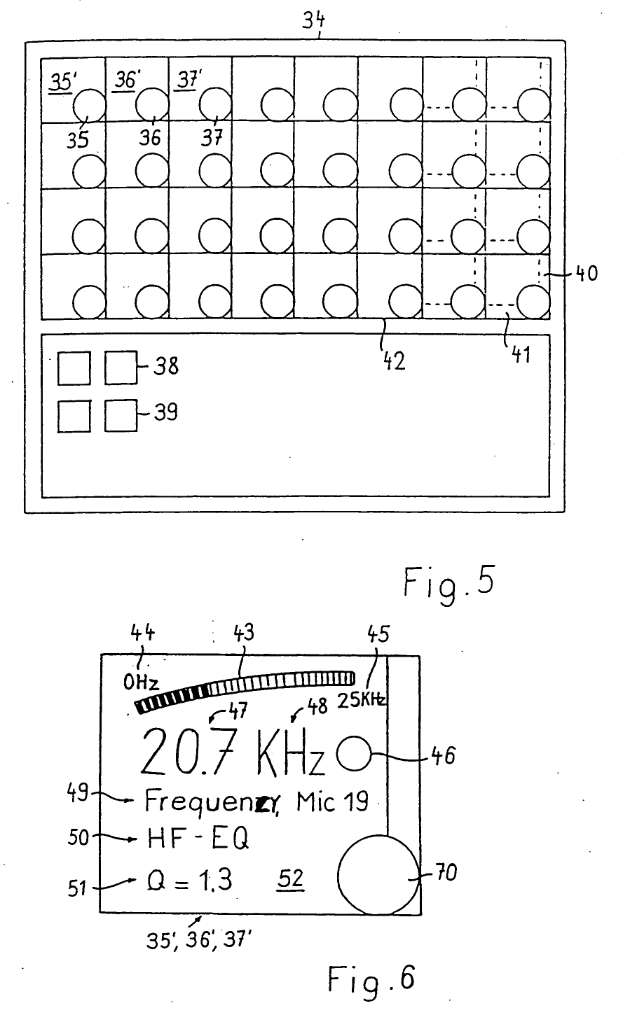

In order to enter values, the belt 14 is driven, on its upper side 19 by a finger, for example. The belt 14 is shifted into a new position with markings on the belt 14, which causes impulses in the sensor 13 to be processed into values in a processing unit in a manner that is known per se and therefore not described in detail here. These values are displayed in a region or field, as shown with 35′, 36′, 37′ in FIG. 5, above the screen 10. The region or field is positioned spatially next to the belt 14.

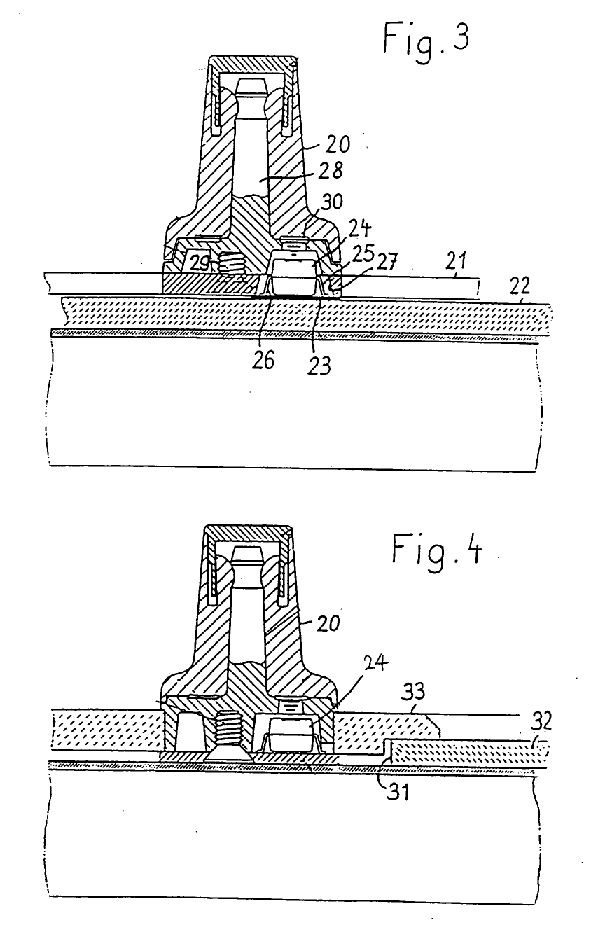

FIG. 3 shows another embodiment of the device having a rotating knob 20 as the entry element. In contrast to FIG. 2, another (optical) element, a touch screen, is provided as the screen 22. The rotating knob 20 is positioned in a pivotable manner on the carrier 21 which is positioned in front of the screen 22. Only a part of the carrier 21 is shown in FIG. 3. Between the screen 22 and the carrier 21, an element 23 is provided for mounting electronic components, such as strip conductors. A sensor 24 is mounted via contacts 25 and 26. The carrier 21 is provided with a recess 27. Additional recesses, although not shown here, may be present and clear the screen 22. On the carrier 21, a bearing 28 for the rotating knob 20 is mounted via at least one bolted connection 29. The rotating knob 20 includes a disc or wheel 30 provided with a code, which is mounted above and is in visual contact to an optically operating sensor 24. The construction elements of the company Hewlett Packard, Type HEDR 8000, for example, are suitable as the sensor 24.

In other embodiment, it is also conceivable to position the sensor and the wires leading to it directly on the surface of the carrier and covered by the rotating knob.

For the purpose of entering values, the rotating knob 20 is rotated by hand with the disc 30. Accordingly, the disc 30 causes an impulse in the optical sensor 24, which processes the value unit into values in a manner that is known per se and thus is not described in detail here. These values are displayed by the screen 22 in the region or field that is next to the rotating knob 20, as shown in FIG. 5.

FIG. 4 shows another possible embodiment with the screen 32, here a touch screen, being mounted with its side wall 31 immediately next to the carrier 33.

In other embodiments according to the invention, other type of sensors than optical sensors can also be used such as sensors using other physical effects, for example, magnetism, ultrasound, etc.

FIG. 5 shows a top view of a device according to the invention in the direction towards a screen 34. The device includes regions 35′, 36′, 37′ for displaying adjusted values and rotating knobs 35, 36, 37 which are elements for entering values. As shown in FIG. 5, more regions and rotating knobs are present. The regions 35′, 36′, 37′ and rotating knobs 35, 36, 37 are assigned to a carrier 42. In addition to the mentioned entry elements, other entry elements, known per se, 38, 39 of a different type can be provided on the same screen, operating with the “touch screen” principle or being activated by means of a mouse. In general, the carrier 42 can be embodied transparently. The screen 34 is positioned behind the carrier 42 and it is visible in all parts not covered by the rotating knobs 35, 36, 37. However, additional regions 40, 41 of the carrier 42 may be covered by strip conductors, e.g., which are positioned above or below the carrier 42 or are provided as foils or are embodied as thin or thick layers. In these additional regions 40, 41, the screen 34 may be covered in a web like fashion, for example, connecting all rotating knobs. In that case, the screen 34 is covered and therefore not visible in the regions 40, 41.

The device according to the invention is particularly advantageous in so called LCD screens. They are advantageously provided with an even surface and reflect regions always in the very same size, once their regions are defined by a program. For instance, a dial is always displayed in the same size and at the same position. LED screens are very easily integrated in a horizontal position and form a part of an audio mixer for sound signals, for instance.

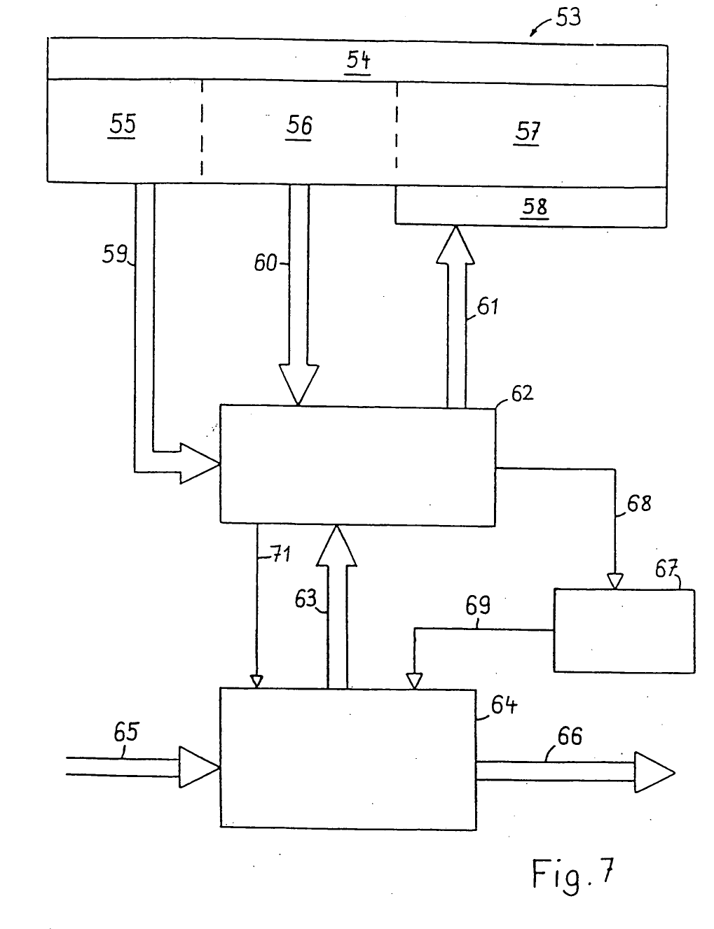

FIG. 6 shows an example of data that may occur in an audio mixer in the regions 35′, 36′, or 37′. Here, these data are values for an audio channel for processing signals, for example. A display 43 identifies a graphic value with regional specifications such as 0 Hz and 25 KHz 44 and 45. A display concerning a control mode is provided in a button 46, indicating whether the control occurs automatically or manually. The absolute value of a parameter 47 such as 20.7 is indicated and the measuring unit used 48, e.g., KHz is indicated. In other places, the name of the parameter set 49 such as Frequency, Mic 19 is named, the name of the parameter such as HF-EQ in 50, and another supplementary display such as Q=1.3 in 51. Additionally, the background color 52 may indicate parameter identification, a level of alarm, etc.

FIG. 7 shows a block wiring diagram of the device according to the invention. FIG. 7 illustrates that the conditions for application in an audio mixer are taken into close consideration, by way of example. An operating surface 53 should be provided with a variety of adjustment elements and display elements such as dials, lamps, etc. as customary in such audio mixers. This operating surface consists of a carrier 54 for operating elements 55 which serve the configuration of the audio mixer, an operating element 56 which serves to influence parameters important for the processing of audio signals, and one or more screens 57 serving to display values, dials, functions, etc. A graphic computer 58 is connected to the screens 57 as well. A computer 62 is connected to the operating surface 53 via one data bus 59, 60, and 61, respectively. The data bus 59 transmits data or commands relating to the configuration of the audio mixer or its changes from the operating elements 55 to the computer 62. The data bus 60 provides the computer 62 with new values from the operating elements 55 concerning the parameters for processing the audio signals or the algorithms used. The data bus 61 transmits data relating to the present state of the audio mixer and the audio signals from the computer 62 to the graphic computer 58 and, thus, to the screen 57. The computer 62 is also connected to a signal processor 64 via a data bus 63 and a bus 71. The signal processor 64 modifies and mixes the primary audio signals, etc. There are several inputs 65 and outputs 66 for audio signals. The signal processor 64 comprises the primary core of an audio mixer, e.g., operating digitally and thus known per se and not shown here. An algorithm library 67 is assigned to the signal processor 64, having saved all algorithms used in the processing of the signals from the input 65. This library is connected to the signal processor 64 via a bus 69 and to the computer 62 via a bus 68.

In an audio mixer of a known type, the operating surface 53 is connected directly to the process computer 64 via suitable means so that the operating elements 55, 56 can directly influence the processing of the signals for the exits 66. In other embodiment, in order to create additional possibilities according to the invention for operating such an audio mixer, a computer 62 is connected between the operating surface 53 and the process computer 64 which protocols the state, i.e., all settings of the audio mixer and the signals pertaining thereto.

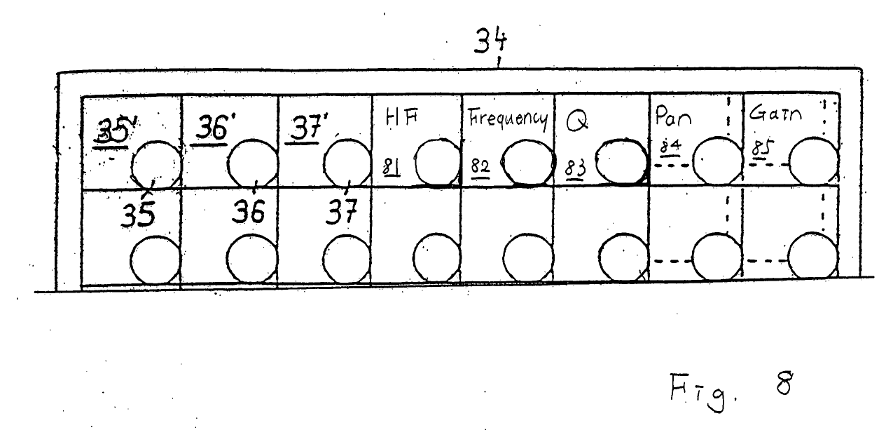

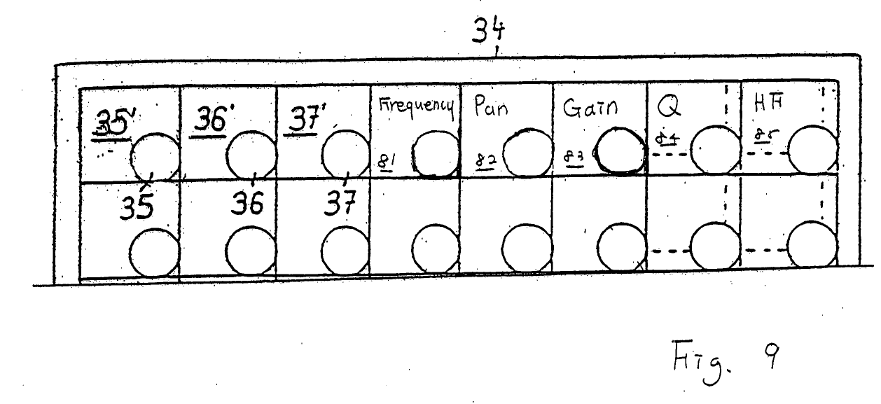

FIGS. 8 and 9 illustrate two different exemplary configurations applied to multiple regions 81, 82, 83, 84 and 85 of the screen 34 of FIG. 5. In FIGS. 8 and 9, the configurations include HF, frequency, Q, Pan and Gain. In FIGS. 8 and 9, when the configuration of the switch board is changed by the operating elements 55, it occurs by means of corresponding data using the data bus 59 to cause the computer 62, on the one hand, to select new algorithms via the bus 68 from the algorithm library 67 and to put them out to the signal processor 64 and, on the other hand, to direct the graphic computer 58 via the data bus 61 to adjust the displays, dials etc. on the screen 57 to the new configuration. In FIGS. 8 and 9, the term configuration defines the entire arrangement provided for the processing of the audio signals. It can be represented in a block wiring diagram, for instance, which lists all processes, such as increases, additions of signals, filters, lever changes, etc. Such a block wiring diagram, being precisely equivalent to a configuration, can be modified by changes of the configuration so that a different block wiring diagram is valid for the processing, etc. If the operating elements 56 are activated, however, the configuration (the block wiring diagram) remains unchanged and only the values of the parameters in the selected parameters are changed, transmitted by way of the bus 71 to the signal processor 64 and are displayed on the screen 57 via the graphic computer 58 as well. This way, such values can be modified as depicted, e.g., in FIG. 6. Assuming the rotating knob 70 serves to provide a filter with a frequency limit, this limit is modified by rotating the rotating knob 70 and its values are displayed in 47. Additionally, it is discernible which channel has been affected by this modification, etc.

Therefore, the computer 62 serves to acquire the state of signal paths, lever positions, filters, the dynamic of modifying processors, and the size of signals, the position and the change of the position of entering elements, etc. and to display them on the screen 57 in a suitable fashion. Additionally, it gives control commands to the signal processor 64 for processing audio and video signals. The user is also guided through this permanently updated display because it is discernible which modifications in different levels were caused by a user's intervention into the existing settings. For example, a modification of the frequency limit of a filter component causes not only the display of the new frequency limit but additionally the updated display of other values dependent on it, such as the lever, etc.

The operating elements 55 represent means for defining the signal flux in the audio channels by selecting the algorithms. In the computer 62, stored program parts define means for determining the assignment of operating elements, for instance, in the meaning that a line or column of rotating knobs on the audio mixer serves to adjust equal parameters, with other parameters being influenced by elements of other lines or columns. This can also mean that singular operation elements can be blocked in a configuration and cannot cause any effect or that several parameters can be modified by a single operation element, e.g., by means of a serial approach. It can simply mean that the language of the labeling can be adjusted at the 49th position etc. or that in some sections of the display the color can be modified rhythmically or can be changed.

We claim:

1. A device for entering values for the processing of audio signals in a signal processor, comprising:
a display screen for displaying the values;
at least two elements arranged in front of the display screen for manually inputting the values;
a carrier for the at least two elements provided in front of the display screen in the direction of view;
a computer being connected to the elements via connections in front of the display screen, where the computer determines a position of the elements by means of data and displays a feedback signal relating to set values in at least one region of the display screen; and
where the computer is connected to the signal processor for the processing of the audio signals such that the computer transmits control commands to the signal processor for processing the audio signals corresponding to settings at the elements.

2. The device of claim 1, where the carrier comprises transparent regions associated with the elements.

3. The device of claim 1, where the computer determines the configuration for the processing of the audio signals in the signal processor.

4. The device of claim 1, further comprising a circuitry arranged for connecting the electronic components between the carrier and the display screen.

5. The device of claim 4, where the circuitry is disposed on the carrier.

6. The device of claim 1, where the elements comprise rotary signal generators.

7. The device of claim 1, where the elements comprise manually movable signal generators.

8. The device of claim 1, where the computer is connected to one of the elements and determines the configuration of the device.

9. The device of claim 1, where the display screen comprises input elements of a different type.

10. The device of claim 1, where, based on displays in regions on the display screen, the computer determines at least one of the state of elements selected from a group consisting of signal paths, level controllers, filters, processors altering the dynamics, the magnitude of signals, the position and the change in position of the elements.

11. The device of claim 10, where the computer presents the determined state of elements on the display screen in a suitable form.

12. An input system, comprising:
a plurality of input units for manually entering at least a first input and a second input, the input units optically generating an electric signal corresponding to the first and second inputs;
a computer coupled to the input units and receiving the electric signal corresponding to the first input via a first data bus and the electric signal corresponding to the second input via a second data bus; and
a signal processor coupled to the computer and processing an audio signal based on the control by the computer, the signal processor receiving the audio signal and outputting the processed audio signal.

13. The input system of claim 12, further comprising:
a display screen for displaying a feedback corresponding to at least one of the first input or the second input; and,
a carrier overlying the display screen and having a transparent portion.

14. The input system of claim 13, where each input unit is assigned with a field and the feedback is displayed in the field.

15. The input system of claim 14, where operation of the input unit and the display of the feedback are in the same view.

16. The input system of claim 12, where the first input changes the configuration and the second input changes parameters of the audio signal.

17. The input system of claim 16, where the computer receives the electric signal corresponding to the first input via the first data bus and provides a new algorithm to the signal processor in response to the received electric signal.

18. An input control device, comprising:
a control member including a coded disc which is in visual contact with an optical sensor;
an at least partially transparent carrier mounting the control member above a display screen;
an electronic circuitry sandwiched between the carrier and the display screen and processing an output from the optical sensor; and
a computer coupled to the electronic circuitry and controlling signal processing.

19. The input control device of claim 18, further comprising an operating surface that includes the control member and a feedback field.

20. The input control device of claim 19, where the control member is associated with the feedback field, and the operation of the control member and the feedback field are in the same view.

21. The input control device of claim 20, where the feedback field displays a visual feedback corresponding to a driving of the control member.

22. The input control device of claim 20, further comprising a secondary control member further associated with the feedback field, where the secondary control member controls a configuration for the signal processing and the control member controls parameters of the signal processing.

23. An audio signal control system, comprising:
a display system that displays multiple parameters of an audio signal;
a manually operable control member optically generating an output and providing a tactile feel; and,
an at least partially transparent carrier mounting the control member above the display system, where the display and the control by the control member are performed in the same view.

24. The audio signal control system of claim 23, where the control member is coupled to a computer via a longitudinal connection through the carrier.

25. The audio signal control system of claim 24, where the computer selects an algorithm that affects audio signal processing based on the control by the control member.

26. The audio signal control system of claim 23, where the control member is assigned with multiple functions.

27. The audio signal control system of claim 23, where the location of the control member is associated with the shape of control member.

28. The audio signal control system of claim 27, where the control member comprises a plurality of control switches disposed at different locations and at least two control switches are simultaneously controllable at the different locations.
